(19) United States
(12) Patent Application Publication
(10) Pub. No.: US 2026/0080625 A1
(43) Pub. Date: Mar. 19, 2026

(54) GENERATING A RENDERED IMAGE OF A THREE-DIMENSIONAL OBJECT

(71) Applicant: Sony Interactive Entertainment Europe Limited, London (GB)

(72) Inventors: Ioannis Andreopoulos, London (GB); Matthias Sebastian Treder, London (GB); Sebastian Alexander Lutz, London (GB); Pinaki Nath Chowdhury, London (GB); Jia-Jie Lim, London (GB)

(21) Appl. No.: 19/395,678

(22) Filed: Nov. 20, 2025

Related U.S. Application Data
(63) Continuation of application No. PCT/GB2024/051347, filed on May 24, 2024.
(60) Provisional application No. 63/503,981, filed on May 24, 2023.

(51) Int. Cl. G06T 17/20; G06N 3/084; G06T 19/20

(52) U.S. Cl. CPC G06T 17/20; G06N 3/084; G06T 19/20

(57) ABSTRACT

Data representing a 3D object to be rendered is obtained, the data comprising: a mesh structure defining 3D co-ordinates for each of a plurality of object vertices; and a feature vector encoding visual characteristics for at least one object surface defined by the plurality of object vertices. Motion information indicative of motion of the object in a scene is received. Based on the motion information, the mesh structure is deformed by adjusting the co-ordinates for one or more of the plurality of object vertices. The deformed mesh structure is processed using a graphics pipeline comprising a vertex shader and a fragment shader to generate a rendered image of the scene. The fragment shader comprises an artificial neural network trained to output pixel colour values for the at least one object surface on the basis of the visual characteristics encoded in the feature vector.

### CROSS-REFERENCE TO RELATED APPLICATIONS

This application is a continuation of PCT. Application No. PCT/GB2024/051347, filed on May 24, 2024, which claims priority to U.S. Provisional Application No. 63/503,981, filed on May 24, 2023, the disclosures of which are incorporated by reference.

### TECHNICAL FIELD

The present disclosure concerns computer-implemented methods of processing image data, and in particular of generating rendered images of three-dimensional objects.

### BACKGROUND

In traditional graphics pipelines, scenes and their constituent objects are represented by one or multiple meshes (e.g. contiguous sets of triangles) that capture the 3D structure combined with several auxiliary texture and feature maps that represent additional surface and reflectance properties such as texture, roughness, bumps, specularities etc. While these techniques are pervasive and widely used in graphics applications from computer games to augmented and virtual reality, architecture and car design, they have limitations due to their discrete approximation of potentially complex and dynamic objects with a set of triangles. Fidelity and realism typically increases with the number of triangles and the size of texture maps, but large meshes pose computational limits to graphics pipelines. There are a number of examples of objects that lead to prohibitively large meshes and texture maps that may lead to performance bottlenecks. First, highly dynamical structures such as fluids and clouds are difficult to be represented by a static mesh. Second, due to the high human sensitivity to faces and facial expressions, and the high amount of idiosyncrasy across individuals, representing human faces accurately requires a potentially prohibitively large amount of resources including fine meshes to capture individual head geometry, multiple high-resolution texture maps to accurately model details such as bumps, hair, pimples, and beauty spots, and high-dimensional motion primitives to capture idiosyncratic facial expressions that are closely tied to an individual's identity. For computational reasons, real-world faces are typically approximated by blendshapes, parametric face models that approximate novel faces as a linear combination of basis functions or eigenfaces. The expressivity of these models is limited by the crudeness of using a linear basis of the approximation, and despite many improvements and non-linear extensions of these models over the years, the ‘uncanny valley’ effect persists.

In recent years, an alternative approach known as neural radiance fields (NeRFs) has become hugely popular in academic research and offers a new way to represent 3D scenes. NeRFs implicitly learn object shape, structure, reflectance, texture etc directly from a set of training images and camera view parameters. If done well, the scene can be rendered from novel viewpoints at high fidelity and spatial consistency. That is, rendered images are photo-realistic and the uncanny-valley effect that is so prevalent in mesh-based approaches is much reduced or absent. However, neural radiance fields also come with some drawbacks. First, their rendering time is very slow compared to the modern 3D graphics pipeline. While real-time rendering of a NeRF is possible on state-of-the-art hardware, it comes at higher usage of computational resources, does not scale well, and is much more difficult to achieve on mobile devices. Second, NeRFs are generative methods and come with the common pitfalls of these approaches: If a scene is rendered from a viewpoint close to the ones seen during training, the rendered images generally look adequate. Rendered from viewpoints far from those seen in the training data, however, the rendered image can contain many artefacts that severely degrade the quality of the image. Since the 3D geometry of the scene is learned implicitly, it is possible that the method learns structures that look viable from the training viewpoints, but inconsistent when viewed from new angles. This problem is exacerbated when moving from static scenes without motion to dynamic scenes that involve movements of parts or other time-contingent visual changes. In dynamic scenes, it is significantly more difficult to disentangle the base structure of a scene and the dynamic motions. This is less of a problem when using traditional methods and meshes, since those have a fixed 3D geometry which limits the range of possible artefacts and there is a large body of research data available to animate them.

The present disclosure seeks to solve or mitigate some or all of these above-mentioned problems. Alternatively and/or additionally, aspects of the present disclosure seek to provide improved methods of generating rendered images of scenes comprising three-dimensional objects.

### SUMMARY

In accordance with a first aspect of the present disclosure there is provided a computer implemented method for generating a rendered image of a scene, the scene comprising a three-dimensional object, the method comprising, at a user device:
obtaining data representing a three-dimensional object to be rendered, the data comprising:
   a mesh structure modelling a geometry of the three-dimensional object, the mesh structure defining three-dimensional co-ordinates for each of a plurality of object vertices; and
   a feature vector encoding visual characteristics for at least one object surface defined by the plurality of object vertices;
receiving motion information indicative of motion of the three-dimensional object in the scene;
deforming the mesh structure by adjusting the co-ordinates for one or more of the plurality of object vertices based on the received motion information; and
processing the deformed mesh structure using a graphics pipeline comprising a vertex shader and a fragment shader to generate a rendered image of the scene,
wherein the fragment shader comprises an artificial neural network, ANN, trained to output pixel colour values for the at least one object surface on the basis of the visual characteristics encoded in the feature vector.

This provides an improvement on known rendering methods by marrying the respective advantages of mesh-based models and of neural radiance fields (NeRFs) by integrating them into a hybrid model. The mesh ensures that the 3D geometry of the captured scene is always consistent and captures all dynamic motion within a video of the scene. The accompanying NeRF sits on the surface of the mesh and can faithfully render any details including material properties, reflectance, shadows, colours and specific texture. The mesh-based approach is used for the vertex shader representing the coarse geometry of the object. A modern neural rendering approach is used after rasterization in order to generate realistic, high-fidelity textures. This combined approach has two benefits: the NeRF itself only needs to learn how to represent the surface details at any given location on top of the mesh and does not need to learn any dynamic motion or global 3D geometry. This allows for a small multilayer-perceptron (or other “lightweight” neural network) to render these details that can be deployed in the fragment shader of any traditional 3D pipeline, vastly increasing the rendering speed compared to standard NeRFs. Additionally, the dynamic motion can be captured by deforming the mesh, which greatly reduces the complexity of the problem.

In embodiments, the feature vector encodes a radiance field for the three-dimensional object. The feature vector may store visual characteristics implicitly, rather than explicitly. This is in contrast with the mesh structure, which explicitly defines 3D coordinates for the object vertices. Encoded visual characteristics may include information such as material, colour, reflectance, roughness, etc. The implicit encoding and entangling of visual information allows for the exploitation of correlations between visual aspects of the scene. The feature vector is queried by the ANN, which maps the visual characteristics implicitly contained in the feature vector into explicit colour values for pixels. The ANN may also take a viewing angle, or “camera position” as an input. In embodiments, the feature vector comprises a multi-dimensional map of texture features (also referred to as an “abstract feature map” or “texture map”) configured to map any point on any surface of the mesh structure to at least one texture feature of the multi-dimensional map. Alternatively, the feature vector may comprise only a single dimension.

In embodiments, the ANN comprises a multilayer perceptron, MLP, configured to transform the visual characteristics encoded in the feature vector into the pixel colour values. An MLP may be less complex and/or less computationally expensive (e.g. more “lightweight”) than other types of neural network. The ANN may comprise other types of neural network in other embodiments.

In embodiments, the ANN is trained by minimising a loss function between pixel colour values predicted by the ANN and pixel colour values of at least one existing image, the loss function comprising at least one of a photometric loss function, a silhouette loss function and a regularisation loss function. Other loss functions may be used in alternative embodiments.

In embodiments, the three-dimensional object comprises one of: a human head avatar for videoconferencing; and a video game character. The three-dimensional object may comprise other types of object in other embodiments.

In embodiments, obtaining the data representing the three-dimensional object comprising retrieving the mesh structure from storage of the user device. As such, the mesh structure may be locally stored on the user device, reducing an amount of traffic sent to the user device. Alternatively, obtaining the data representing the object may comprise receiving the mesh structure from a further entity, e.g. a server.

In embodiments, obtaining the data representing the three-dimensional object comprises retrieving the feature vector from storage of the user device. As such, the feature vector may be locally stored on the user device, reducing an amount of traffic sent to the user device. Alternatively, obtaining the data representing the object may comprise receiving the feature vector from a further entity, e.g. a server.

In embodiments, one or more of the visual characteristics encoded in the feature vector are dependent on the motion of the three-dimensional object in the scene.

In embodiments, the feature vector and the ANN are trained together in an end-to-end manner using back-propagation of errors.

In embodiments, the mesh structure is generated using a mesh generating ANN, the mesh generating ANN being configured to output a mesh structure based on at least one existing image to minimise a loss function between rendered mesh points of the outputted mesh structure and pixel colour values of the at least one existing image, the loss function comprising at least one of a photometric loss function, a silhouette loss function and a regularisation loss function.

In embodiments, deforming the mesh structure comprising processing the received motion information using a deformation ANN, the deformation ANN being configured to output, based on the motion information, a vector that parameterizes an update function for adjusting the co-ordinates of the one or more of the plurality of object vertices, by minimising a loss function between at least one existing image and a rendering of the mesh structure after the parameterized update function has been applied to the mesh structure, the loss function comprising at least one of a photometric loss function, a silhouette loss function and a regularisation loss function.

In embodiments, deforming the mesh structure is based on a three-dimensional warp field, and wherein the three-dimensional warp field covers only a portion of the mesh structure. As such, only a portion of the mesh structure may be deformed (or be subject to possible deformation) in some embodiments. For example, where the object is a human head avatar, the warp field may be applied to the face only, and the remaining portions of the head may remain static.

In embodiments, the motion information is generated by a motion encoder comprising an artificial neural network configured to encode a motion vector based on at least one existing image. In embodiments, deforming the mesh structure comprises, at a motion decoder comprising an artificial neural network: decoding the motion vector encoded by the motion encoder, and determining, based on the motion vector, offsets for adjusting the co-ordinates of the one or more of the plurality of object vertices.

In embodiments, the motion information comprises data indicative of a weighted combination of blendshapes. For example, the motion information may comprise a set of weights to be applied to a plurality of predetermined blendshapes to combine the blendshapes.

In embodiments, the method comprises applying back-propagation of errors and stochastic gradient descent, using at least one loss function, to adjust parameters of one or more of: the artificial neural network comprised in the fragment shader; the feature vector; the mesh structure; a motion encoder configured to generate the motion information; and a deformation function configured to perform the deforming of the mesh structure.

In embodiments, the method comprises modifying the feature vector based on the received motion information. As such, the feature vector need not be fixed, but may be modified based on motion of the object. Alternatively, the feature vector may remain fixed for a given object.

In embodiments, the method comprises receiving, in an initial or offline stage, at least one of the mesh structure and the feature vector. In embodiments, the method comprises storing the at least one of the mesh structure and the feature vector in storage of the user device. As such, the mesh structure and/or the feature vector for a given object may be sent to the user device only once, and then stored on the user device throughout operation, thereby minimising an amount of traffic sent to the user device. In alternative embodiments, the mesh structure and/or the feature vector are sent to the user device more than once.

In accordance with another aspect of the disclosure there is provided a computing device comprising:
a processor; and
memory;
wherein the computing device is arranged to perform using the processor any of the methods described above.

In accordance with another aspect of the disclosure there is provided a computer program product arranged, when executed on a computing device comprising a processor or memory, to perform any of the methods described above.

It will of course be appreciated that features described in relation to one aspect of the present disclosure described above may be incorporated into other aspects of the present disclosure

### DESCRIPTION OF THE DRAWINGS

Embodiments of the present disclosure will now be described by way of example only with reference to the accompanying schematic drawings of which:

FIGS. 1(a) to 1(c) are schematic diagrams showing a neural network in accordance with embodiments;

FIG. 2 is a schematic diagram showing a neural network in accordance with embodiments;

FIG. 3 is a schematic workflow diagram showing an example training process in accordance with embodiments;

FIG. 4 is a schematic workflow diagram showing an example inference process in accordance with embodiments;

FIG. 5 is a flowchart showing the steps of a method of generating a rendered image in accordance with embodiments;

FIG. 6 is a flowchart showing the steps of a method of generating a rendered image in accordance with embodiments; and

FIG. 7 is a schematic diagram of a computing device in accordance with embodiments.

### DETAILED DESCRIPTION

The presently disclosed methods generate dynamic neural radiance fields that can be rendered in real-time on mobile and desktop devices and comprise two parts: the sender and the receiver. Given a neural radiance field of the captured content in a base or static pose, the sender can capture a video of the content in real-time and encode all dynamic changes and encode them to be sent to the receiver. The receiver can use this encoded information to update their neural representation of the content which will reflect the dynamic changes captured by the video on the sender side and be able to render the content from any virtual camera in real-time. This virtual camera can have any position and viewing direction in the 3D space, as well as any type of camera lens, allowing for artistic freedom in the way the content is viewed on the side of the user. An instantiation of the disclosed methods is able to render HD videos of the captured content at 30 frames per second. The expected quality scores (measured in objective or subjective image/video metrics, such as PSNR, SSIM, FID, or mean opinion scores from human viewers, etc.) are increased over known methods. Embodiments of the presently disclosed methods have at least some of the following characteristics:
1. Hybrid approach combining mesh-based and neural rendering. The rendering pipeline is bifurcated into a traditional graphics pipeline and a second component using modern neural rendering. A traditional mesh-based approach is used for the vertex shader representing the coarse geometry of the object. A modern neural rendering approach is used after rasterization in order to generate realistic, high-fidelity textures.
2. Integration of neural renderer into the fragment shader using multi-dimensional feature maps. During training of the neural model, an abstract multi-dimensional feature map is created that implicitly encodes spatially dependent visual properties. It is trained jointly with a small MLP that translates these abstract features into concrete visual properties. Since the MLP is light-weight and can be represented by a series of linear operations and non-linear activation functions, it can be included directly in the fragment shader. This allows for the seamless integration into existing graphics pipelines. In particular, our hybrid neural assets can be used simultaneously with assets based on traditional texture maps.
3. Integration of temporal dynamics. The multi-dimensional feature represents not only static visual object properties such as colour, reflectance, and roughness, but also dynamic properties such as wrinkles that only show when frowning. This is done by conditioning the feature map on a motion code extracted by the encoder.

To establish the required base or static pose of the captured content the method may be trained on a limited set of images showing the content from multiple viewing angles. During the training process the method will decompose the content into static and dynamic parts which will allow the method to encode the dynamic changes to the content during inference and decode this information to update the neural representation of the content on the receiver side.

The presently-disclosed methods provide improvements over known methods of generating rendered images of scenes and/or objects.

Some known methods (e.g. “MobileNeRF” methods) use a neural radiance field (NeRF) representation based on textured polygons. During training, such methods learn a polygon mesh and a texture consisting of features and opacities. This mesh can be rendered using a standard rendering pipeline, resulting in an image with these abstract features at every pixel. These features may then be processed by a light-weight neural network to produce a final pixel colour. This rendering approach may be more efficient than the traditional way NeRFs are rendered using ray marching. However, these methods only allow for static meshes and use static texture maps. In contrast, the presently-disclosed methods may feature inherently dynamic meshes and support both static and dynamic textures.

Other known methods (e.g. “NeRF2Mesh” methods) also recognize the inefficiency of traditional volumetric rendering and transform a trained NeRF into a polygon mesh and texture maps that capture the appearance of the scene. These assets can then be rendered using a standard 3D rendering pipeline without any further use of neural networks. However, similar to MobileNeRF, this known method is only suitable for static scenes and can not capture any dynamic motion. The method also focuses on building a highly accurate polygonal mesh, whereas the mesh learned in MobileNeRF serves more as a scaffolding to the MLP deployed after the pixelization stage. The presently-disclosed methods differ significantly from these known methods e.g. through the capture of dynamic motion and the use of neural networks in the rendering stage.

Other known methods (e.g. “Instant Volumetric Head Avatars”) use a parametric face model to encode points in 3D space to query a NeRF. This allows them to encode dynamic expressions of the face directly using the face model. Such a method is restricted to any dynamic motion that can be modelled using the parametric face model, i.e. only face and head motions, whereas the presently-disclosed methods work more generally by learning a base mesh and a deformation decoder.

The presently-disclosed methods improve on these known methods by marrying the respective advantages of mesh-based models and of NeRFs by integrating them into a hybrid model. In particular, meshes are integrated as part of the neural radiance field itself. The mesh ensures that the 3D geometry of the captured scene is always consistent and captures all dynamic motion within a video of the scene. The accompanying NeRF sits on the surface of the mesh and can faithfully render any details including material properties, reflectance, shadows, colours and specific texture. This combined approach has two benefits: the NeRF itself only needs to learn how to represent the surface details at any given location on top of the mesh and does not need to learn any dynamic motion or global 3D geometry. This allows for a small multilayer-perceptron (or other “lightweight” neural network) to render these details that can be deployed in the fragment shader of any traditional 3D pipeline, vastly increasing the rendering speed compared to standard NeRFs. Additionally, the dynamic motion can be captured by deforming the mesh, which greatly reduces the complexity of the problem.

Embodiments of the presently-disclosed methods include a neural renderer (a neural model deployed in the fragment shader), and a bespoke training process that produces a base mesh of the scene, a set of abstract feature maps, the weights of the neural renderer, and a dynamic decoder that can update the base mesh based on the motion within the scene.

The following sections are organised as follows. First, we describe example neural network architectures and processes which may be used to implement the presently-described methods. Second, we expand on the training process wherein the neural renderer, the base mesh, the motion decoder and the feature maps are trained jointly. Third, we explicate the deployment of the neural renderer and abstract feature maps in a graphics pipeline. Fourth, we explicate how we assure the high visual quality of the model, and provide for adaptive quality, rendering and/or bitrate.

### Neural Network Architectures

As embodiments of the presently-disclosed methods use neural network architectures and training with back-propagation and stochastic gradient descent, we elaborate on example embodiments of these architectures and training in this part. We note that whenever the term ‘training’ or ‘learning’ is used, it refers to adjusting weights or parameters via backpropagation and stochastic gradient descent of the nature described in the embodiments found below. This can relate to the adjustment of weights or parameters of an explicit neural network architecture, such as a multilayer perceptron or a convolutional neural network, or the adjustment of feature parameters, embeddings, or function parameters using backpropagation and stochastic gradient descent. Similarly, the term ‘pretrained’ means that such a model has been trained on a different dataset prior to usage in our approach. A pretrained model can either be used directly or its weights can be continued to be trained (in general, on a different dataset) along with the other components of our framework. The latter procedure is called ‘fine-tuning’.

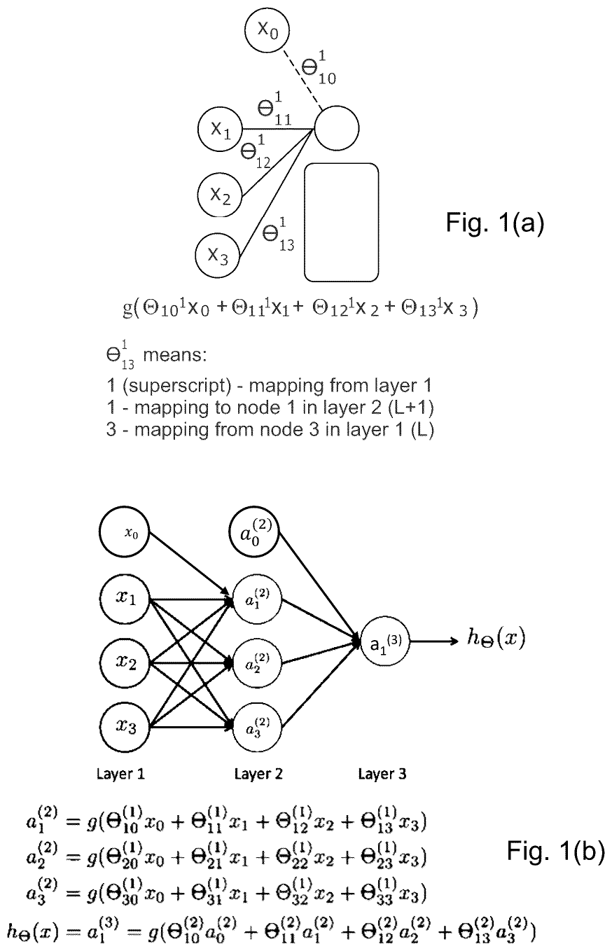

An example embodiment of utilised neural network weights is provided in FIG. 1(a), which shows a combination of inputs with weight coefficients matrix and non-linear activation function. An associated instantiation in FIG. 1(b) showcases global connectivity between weights and inputs. That is, FIG. 1(b) shows layers of interconnected activations and weights, forming an artificial neural network with global connectivity. An instantiation of local connectivity between weight connecting input and output is shown in FIG. 1(c) for one of the computations of a convolution. In particular, FIG. 1(c) shows back-propagation of errors from the coefficient of an intermediate layer to the previous intermediate layer using gradient descent. The activation function applied to produce an output may comprise a parametric ReLU (pReLU) function, or another non-linear function like ReLU or sigmoid. FIG. 1(c) also shows connections from output to the next-layer outputs via weights. It also illustrates how back-propagation based training can feed errors from outputs back to inputs. The illustrated errors are indicated by, and they are computed from errors of subsequent layers, which, in turn, are computed eventually from errors between network outputs and training data outputs that are known a-priori. In the present disclosure, such a-priori known outputs may comprise test 2D or 3D images, meshes, point cloud data or precomputed features, with the distinction between them provided by the context. These are given as input training data and the network outputs comprise the inferred outputs that attempt to approximate the provided ones. The errors between network outputs and training data are evaluated with a set of functions, termed “loss functions”, which evaluate the network inference error during the training process using appropriate loss or cost functions to the problem at hand. More details on instantiations of neural networks and loss functions within the presently-disclosed methods are provided in the related parts of the description. If the training data is just input data and the network starts from such data and is designed to derive a compact feature representation and then expand it to reconstruct the input data, the process of training is also termed as ‘self-supervised’training or autoencoder training or feature extraction from the compaction stage of the neural network architecture, where no external ‘labels’ or annotations or other external metadata are needed for the training data.

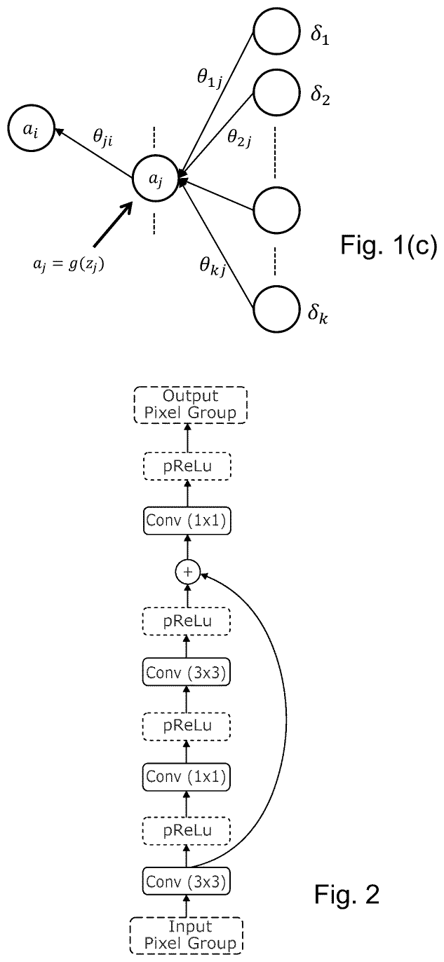

Embodiments of encoding of the input into a compact latent representation and generation of the reconstructed signal from a latent representation involve convolutional neural networks (CNNs) consisting of a stack of convolutional blocks (conv blocks), as exemplified in FIG. 2 and stacks of layers of fully-connected neural networks of the type shown in FIG. 1(b). In particular, FIG. 2 shows a cascade of conditional convolutional and parametric ReLu (pReLu) layers mapping input pixel groups to transformed output pixel groups. All layers receive codec settings as input, along with the representation from the previous layer. There is also an optional skip connection between two intermediate layers. Some layers may also have dilated convolutions or pooling components to increase or decrease resolution of the receptive field, respectively. As before, in some embodiments, the convolutional blocks can include dilated convolutions, strided convolutions, down/up-scaling operations (for compaction and expansion, respectively, also termed as convolution/deconvolution, normalisation operations, and residual blocks. In certain instantiations, the CNN includes a multi-resolution analysis of the image using a U-net architecture. The output of both CNNs can be either a 2D or 3D feature block (or reconstructed 2D image or 3D video frames, or feature layers composed of features from a graph convolution step), or a 1D vector of features. In the latter case, the last convolutional layer is vectorised either by reshaping to 1D or alternatively by using a global pooling approach (i.e., global average pooling or global max pooling). In such cases, the dimensionality of the vector is the number of channels in the last convolutional layer. If the output is 1D, the vectorisation is typically followed by one or more dense layers. Finally, some embodiments of CNNs and fully-connected neural networks trained to predict the next output and operating within a window of inputs and intermediary features form what is known as an “attention” module, with common instantiations of this module being called a “transformer”. In the present disclosure, some or all of the above-described components may be used in embodiments of the different components of the methods when the terms “neural network” or “training” are used.

### Training

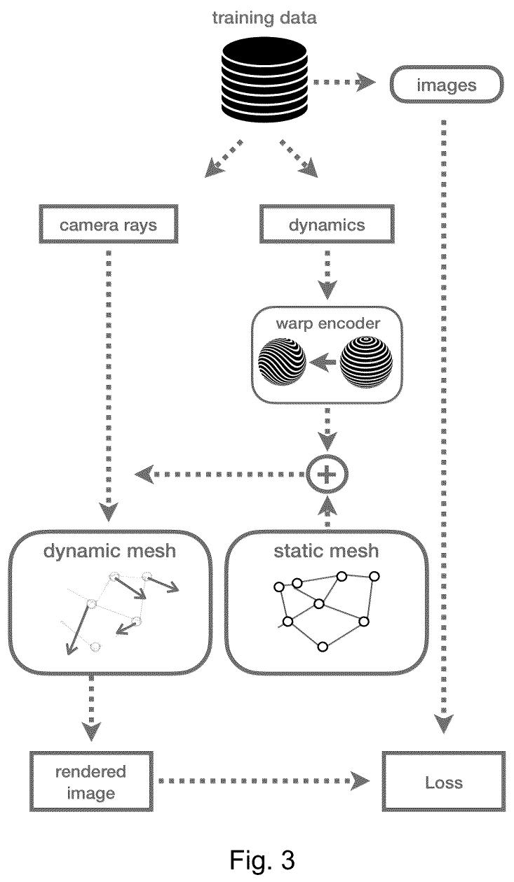

FIG. 3 shows schematically an example training process for the presently-disclosed methods. The training dataset contains images and the corresponding camera parameters, from which camera rays for every pixel can be calculated. A static (base) mesh alongside an abstract texture map is learned by calculating a loss between the static parts of the images and the rendered mesh. The static and dynamic parts are learned by estimating the motion between different images of the dataset. The dynamic parts are additionally used by a warp encoder to deform the static mesh on a per-image basis to generate the dynamic mesh.

As a training dataset, embodiments of the presently-disclosed methods use a limited amount of images from different viewpoints of the scene. The exact amount of required data is a function of the complexity of the asset that will be represented. For easily constrained objects (e.g. cars all have a very similar geometry) only a few dozen images are needed, whereas complex and highly dynamical objects with complex deformations (e.g., a human performing a dance or the movement of a wave) requires a larger number of images. The training images can be unconstrained otherwise, i.e. they can originate from multiple cameras, taken at different points in time, and show either a static or highly dynamic scene.

Embodiments of the presently-disclosed methods use these images as training data in a neural network training pipeline to simultaneously construct three entities: (i) a base mesh representation of the scene that involves one or multiple meshes that tightly fit the geometry of the depicted objects; (ii) an abstract feature map (having one or multiple dimensions) implicitly encoding the appearance of the scene and its constituent objects at any point; and (iii) a feature renderer that, provided with the abstract feature map, within-object coordinates and the viewing direction, renders the final colour of any pixel in a scene.

Depending on the task and data, the base mesh can be defined in several ways. In most cases the scene itself consists of one or several foreground objects located in an unique environment. In cases such as this the background environment may be modelled neurally and the base mesh and abstract feature map produced only for the foreground objects. Modelling the background even if it will not be used downstream is helpful to disentangle the foreground and background, and guide the method to faithfully extract the desired mesh from the scene. In some other cases, however, it might be desirable to extract the mesh for the whole scene, including the background environment. In cases such as this, we still separate the foreground and background and create multiple meshes, but the background can be constructed as well. In this case, there are some limitations to consider for the creation of the background. Essentially, in some scenes it may be impractical to fully mesh the environment if it would be too large. For instance, a scene illustrating the view from the top of a mountain, where the background environment consists of all the landscape that can be seen from the mountaintop, is difficult to accurately model. Therefore only the immediate surroundings may be modelled as a mesh and large parts of the distant environment will only be represented neurally.

The base mesh is defined in terms of the vertices V_{base}∈ [symbol] ^{3×N} and corresponding faces F∈ [symbol] ^{3×M}, where N is the number of vertices and M is the number of faces for a triangular mesh. It can be constructed in a number of ways. For instance, the images can be fit directly to a template mesh that is domain specific to be a modelled asset (e.g., a head mesh for modelling head avatars). In the absence of a default mesh, either a generic mesh (e.g., a sphere for convex objects) is mapped onto the images or, if a 3D representation of the object is available, vertices and edges can be created using an algorithmic approach such as marching cubes. In embodiments, the method maps static and dynamic parts of the scene onto different model components. Only static parts are used to build the base mesh. The dynamic parts are used separately in an encoder-decoder structure to learn vertex offsets that deform the static mesh such that it fits the (dynamic) image during training. These offsets can be represented jointly as a time-dependent offset matrix V_{offset}(t)∈ [symbol] ^{3×N}. After training the method therefore has extracted a base mesh from the scene that contains all static parts and is able to encode dynamic parts of the scene such that a decoder can produce vertex offsets to the scene mesh that can transform the base mesh to a mesh that fits the image. At inference time, the final dynamic mesh is given as the sum of the static base mesh and its dynamic offset.

$${V}_{d y n a m i c} ( t ) = {V}_{b a s e} + {V}_{offset} ( t ) \qquad ( Eq . 1 )$$

Simultaneously, a multi-dimensional abstract feature map is learned that encodes the radiance field of each part of the scene. We call the map abstract because its dimensions encode visual attributes such as material, colour, reflectance, roughness, etc. implicitly not explicitly. The implicit encoding and entangling of visual information allows for the exploitation of correlations between visual aspects of the scene. The resultant compression allows for the transport of more detail using the same texture size. The decompression and rendering into output colours is jointly performed by the feature renderer. Similar to a conventional texture, the abstract feature map can have a two-dimensional spatial arrangement. In other words, every face of the mesh corresponds to some part of this texture and can query this information. Formally, we can represent the abstract feature map as a tensor Fₐ∈ [symbol] ^{H×W×N} where H and W represent the spatial dimensions of the map and N represents the dimensionality of the map. The advantage of a fixed abstract feature map is that it can be saved and transported to the receiver once, minimising the amount of traffic between sender and receiver during deployment. However, it is also possible to model the abstract feature map as a function that maps any surface point on the mesh to a feature embedding using any neural architecture, such as a MLP.

Optionally, higher fidelity can be obtained at the cost of additional compute and traffic by additionally constructing a residual map Fᵣ during online operation that is able to encode additional features and high frequency detail, and which is used to update the abstract feature map. In the latter case, the feature renderer uses the joint time-dependent map

$${F}_{t} = {F}_{a} + {F}_{r} = {F}_{a} + E ( {I}_{t} ) \qquad ( Eq . 2 )$$

where the residual map is the output of an encoder encoding image the current input image Iₜ.

The task of the feature renderer is to simultaneously unpack the abstract feature map and produce the desired colour values as a function of viewing direction and possibly auxiliary data. Formally, we can represent the feature renderer as the function R: (F, d; ξ)→ [symbol] ³ that uses the information from the feature map in addition to the viewing direction to produce the final colour output, where F is either the abstract feature map Fₐ or its time-dependent, adaptive equivalent Ft. Furthermore, d is the viewing direction, and ξ is an auxiliary information vector that includes a description of the motion dynamics which allows for the appearance of texture details contingent on the expression (e.g., wrinkles around the eyes when smiling) In addition, ξ can be expanded to include further information such as lighting parameters or timestamps. In embodiments, a light-weight multi-layer perceptron (MLP) is used for R. The corresponding model is trained end-to-end along with the abstract texture map to assure optimal fidelity. The operation of the MLP is formally defined as a cascade of affine transformations Aᵢ·+bᵢ with a matrix Aᵢ and vector bᵢ as well as activation functions σᵢ (e.g., the Rectified Linear Unit σᵣₑₗᵤ(x)=max(0, x)). It is denoted as:

$$R : {σ}_{L} ∘ ( {A}_{L} \cdot + {b}_{L} ) ∘ … ∘ {σ}_{2} ∘ ( {A}_{2} \cdot + {b}_{2} ) ∘ {σ}_{1} ∘ ( {A}_{1} \cdot + {b}_{1} ) \qquad ( Eq . 3 )$$

for an MLP with L layers, where º refers to the chaining of operations and the · is a placeholder for the input element. The MLP is executed in the fragment shader and receives as input a sample of the abstract feature map at a specific spatial location. The last layer maps the features onto an output vector of dimension 3 representing RGB values.

The learnable parameters of the overall model are randomly initialised at the start of training and then iteratively updated using backpropagation. Learnable parameters include the abstract feature map and the feature renderer. These parameters are updated using one or more of the following loss functions:
a. Photometric loss. An image I is compared to image I rendered using the same parameters via the pixel-wise L2 loss, L_{photometric}(I, Ĩ)=|I−Ĩ|₂ or any pixel-wise loss such as L1, Huber, etc.
b. Silhouette loss. A segmentation mask M of the foreground object is compared to the silhouette image \hat{M} via the pixel-wise L2 loss, Lₛᵢₗₕₒᵤₑₜₜₑ(M, \hat{M})=|M−\hat{M}|₂ or any other pixel-wise loss such as L1, Huber, Dice, etc.
c. Regularisation loss. Several aspects of the method can be regularised for better minimisation and results. These are dependent on the scene that is trained and can include:
   i. A loss to smoothen the surface normals of the foreground object.
   ii. A loss on the NeRF opacity prediction to predict either fully empty space or density connected to larger regions.
   iii. A loss to keep coefficients low when predicting colour as the combination of spherical harmonics.

Two examples of learning the dynamic mesh are described, though it will be understood that other methods are possible. In some instances the static and dynamic parts of a scene are easily separated. This would be the case for capturing human head avatars, where the subject could be captured first in a neutral pose without movement and afterwards captured doing a set of facial expressions. In cases such as this a two-step training approach is implemented. In the first stage the method is only trained on the static images and learns a static mesh. No dynamics are captured and the encoder/decoder responsible for the dynamics are not trained in this stage. Using the static mesh as fixed base mesh, in the second stage, the dynamic parts of the scene are trained on the dynamic images. All parts of the method that were trained in the previous stage are fixed and only the encoder that captures the dynamic motion in the scene and outputs a motion vector, as well as the decoder that uses the motion vector to predict vertex offsets are trained. Optionally and depending on the dataset the abstract feature map can be trained using a lower learning rate if necessary to capture details that only appear during motion.

In some other instances, algorithms already exist to produce dynamic meshes for a scene. Methods such as mediapipe can predict 3D landmarks of facial features, which can be combined to a crude dynamic mesh. During the training of the present embodiments, these approaches can be incorporated as auxiliary information. The presently-disclosed embodiments generally produce higher quality meshes with more vertices than these methods, but the changes in topology due to the dynamic motion of the scene should be correlated between our dynamic mesh and the auxiliary one. This allows for the integration of additional loss functions that can match our dynamic motion to the given one. In some cases it is also possible to directly use the dynamic meshes produced by auxiliary methods. We simply reformulate our vertex offset operation to combine our learned base mesh directly with the given auxiliary mesh instead of calculating vertex offsets.

In addition to the dynamic mesh, embodiments of the dynamic encoder/decoder are described. In the most basic case, the vertex offsets are predicted using a 3D warp field. The encoder predicts warp coefficients for the dynamic parts of the image, which are transferred to the receiver. The decoder uses the warp coefficients to estimate a full 3D warp fields, which is used to offset the vertices of the base mesh to capture the dynamic motion. In some cases the dynamic parts of the scene are easily distinguished from the static parts and the estimated warp fields need not cover the whole mesh. For instance, in the case of head avatars one could designate only the face as dynamic and keep the rest of the head static. This would lower the complexity of the task and increase the offset fidelity of the important face parts.

For some meshes, it is also possible to use a transformer structure to estimate the offsets. Each vertex or vertex region can be encoded as a token within a transformer encoder stack, conditioned on a vector describing the dynamic motion (given by the encoder). The transformer stack will then output updated positions for each vertex (or vertex region). This method may be bound by the number of tokens, however, and may not be used for an arbitrary number of vertices. Finally a MLP can be deployed on each vertex individually, conditioned on a vector estimating the motion.

### Deployment

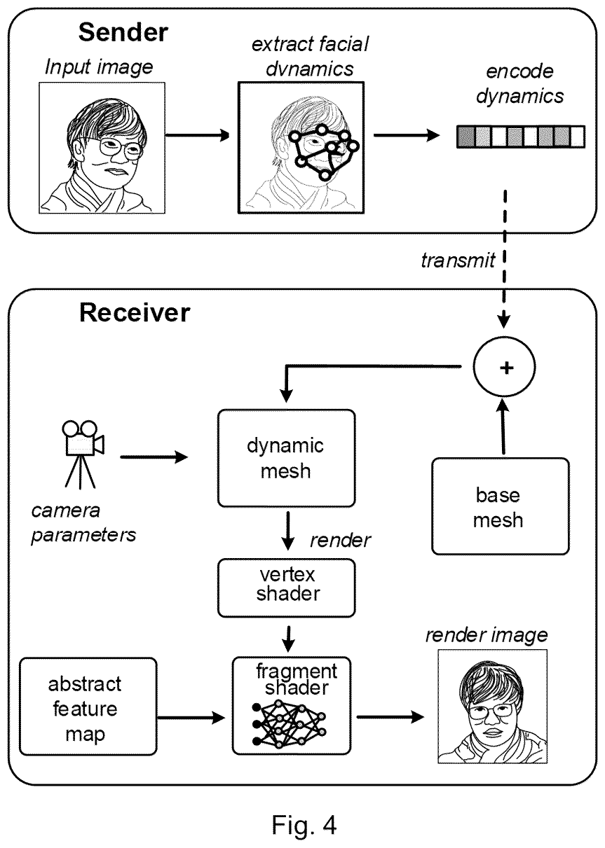

FIG. 4 shows schematically an inference process of the method. Both the sender and receiver have access to the base mesh and the abstract texture map. On the sender side, the warp encoder is used to estimate dynamic motion (e.g. facial expressions) and sends this information to the receiver. The receiver uses this information to deform the base mesh into a dynamic mesh, which is rendered using the standard 3D graphics pipeline. The abstract feature map is used in the fragment shader by a small MLP to estimate the final colours.

As such, during deployment, embodiments of the presently-disclosed methods may comprise of two parts, the sender and the receiver. The sender part receives as input a video stream (e.g., live feed from a laptop camera), encodes the dynamic parts of the scene and sends this information to the receiver. The receiver already has access to the base mesh of the scene and the abstract feature map. Given the encoded dynamic information sent from the sender and a target camera view, the receiver calculates vertex offsets to the base mesh that reflect the dynamics in the captured video stream. Optionally the texture information can be updated using the same information. The updated mesh is then rendered using a standard 3D graphics pipeline containing a vertex and fragment shader. However, instead of using several texture maps as is the case in modern 3D graphics, the previously trained multilayer perceptron is used in the fragment shader to render the final colours for every pixel.

### Quality Assurance

When capturing a scene, embodiments of the presently-disclosed methods encode the dynamic parts of the scene and send this encoded information to the receiver. In addition, the method has a built-in quality-assurance component. On the sender side, the method can use a virtual receiver to render the scene from the initial camera angle. This allows direct comparison between the rendered image and the input image, using perceptual quality metrics such as SSIM, VMAF, or LPIPS. If those metrics exceed a given quality threshold, the sender can send on the information to the receiver as usual. If the quality metrics are not satisfied, however, the sender can opt to update the information to be sent to increase the quality.

An example embodiment of a quality assurance approach is the following iterative process: Since the sender has access to the ground truth image from the camera viewpoint, dynamics can be calculated and translated into vertex offsets, and the resultant asset can be rendered. The rendered image can be compared to the ground truth using one of the aforementioned image quality metrics. Since these metrics are differentiable, if the quality does not surpass a criterion value, vertex offsets can be recalculated given the previous offsets and error gradients as inputs. This leads to an iterative improvement in image quality.

### Adaptive Quality

Embodiments of the presently-disclosed methods operate in a context of several constraints such as information bottlenecks, device capability and computational load. The rendering performance of the receiver is mainly bound by two tasks: Calculating the vertex offsets of the mesh and the per-pixel computation of the MLP in the fragment shader. The bitrate that is used to transmit the information from the sender to the receiver is bound by the size of the information the receiver needs to calculate vertex offsets. Both of these can be addressed in an adaptive way.

### Adaptive Rendering

The performance of the feature renderer implemented as an MLP in the fragment shader is a function of the number of layers and number of neurons in each layer of the MLP. During training, it is possible to train multiple MLPs with different topologies simultaneously. These MLPs then realise different trade-offs between fidelity (more layers/neurons=higher fidelity) and computational performance (less layers/neurons=better performance). The MLPs use as input the viewing direction and the abstract feature map. Smaller MLPs can be trained to only use a subset of channels of the feature map as input and have a smaller architecture, whereas larger MLPs can use the full map as input and have more and larger layers. Since all MLPs are trained to replicate the input image during training, but some of them use less channels of the texture as input, the learned texture will prioritise storing the most relevant information in the channels of the texture that is used by all MLPs. The extra channels will contain more detailed information that will enhance the overall quality of the rendering but is not strictly necessary. In this way, devices with more limited computation power can make use of the smaller MLPs to render the scene, while more powerful devices can render the full range of details using the larger ones. This leads to a consumer-device dependent selection of the feature renderer to realise an optimal fidelity-performance trade-off. Additionally, since the MLPs are very small in size, they can all be stored in memory simultaneously and swapped out during operation. This swapping of MLPs can be informed by device performance characteristics such as current computational load (switch to smaller MLP when GPU load is high), power source (switch to smaller MLP when the device runs on battery rather than a power cable) and target screen (switch to smaller MLP for small screens with less detail information requirements).

### Adaptive Bitrate

In embodiments, the presently-disclosed methods operate on a fixed abstract feature map for each object. This may be the default mode of operation. The feature map and the base mesh have to be transferred to the receiver only once and thus only create a brief bitrate spike the first time sender and receiver interact. Both mesh and feature map are initially encoded in float32 format. To reduce the transmission footprint, mesh and feature map can be represented at lower accuracy (e.g., float16) or quantized using either a fixed quantization transform (e.g., to uint8) or learned quantization using clustering techniques such as k-means. Additionally, a dimensionality reduction technique such as Principal Component Analysis can be employed for further compression.

Afterwards, only data representing object dynamics contributes to bitrate. The abstract feature map can be made more flexible by allowing for an additional, time and input dependent residual (compare Eq. 2). This allows for changes to the feature map to be transmitted during operation and allows for greater dynamic changes and high-frequency detail conditioned on time or motion. However, it requires the residual information to be transmitted on either a frame-by-frame basis or just occasionally. Summarising, we can differentiate three different transmission intervals for the abstract feature map.
1. Fixed abstract feature map. The map is transmitted once to the receiver.
2. Abstract feature map with residual, transmitted in intervals. The fixed abstract feature map is transmitted once to the receiver. Additionally, occasionally a residual is transmitted as a refinement step. Transmission frequency can be decided algorithmically by the sender. For instance, for a continuously changing object (e.g., an avatar that ages or otherwise physically transforms over time) the sender could send an updated residual whenever the difference between the current residual and the previously sent residual exceeds a threshold. This has the effect of occasional spikes in bitrate while preserving a constant lower bitrate for all other frames.
3. Abstract feature map with residual, transmitted on a frame by frame basis. For a highly dynamic asset (e.g., a breaking wave or an object undergoing transformation or morphing) updates to the residual map might be required on a frame by frame basis.

Another scenario would be a high information bandwidth along with the need for high-frequency detail (e.g., displaying the object on a 4K screen).

These three options represent different trade-offs on the fidelity-bitrate spectrum as well as computational resources on the sender side (which performs the encoding of the residual). The trade-off can be decided a priori based on the available quality of communication lines and the complexity or dynamicness of the object. Alternatively, it can be decided dynamically over time, with the residual map being transmitted whenever bandwidth and computational resources permit.

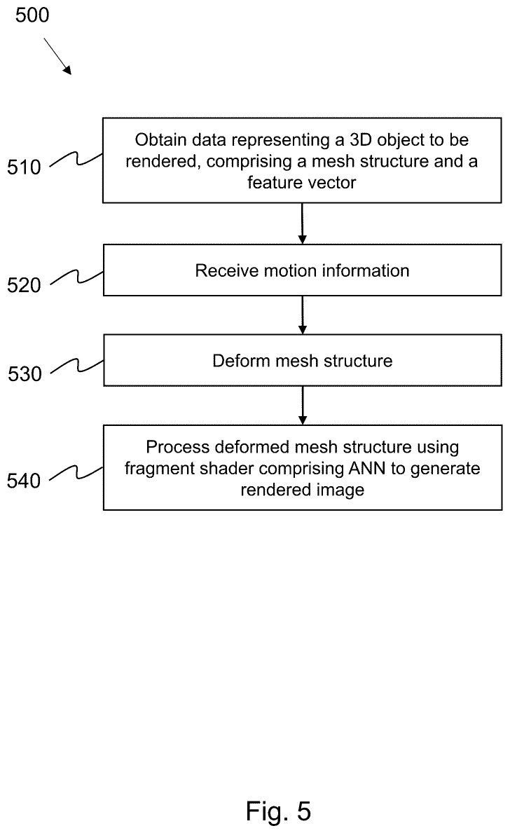

FIG. 5 shows a method 500 for generating a rendered image of a three-dimensional object. The method 500 may be performed by a computing device, according to embodiments. For example, the method 500 may be performed at least in part by a user device, such as a mobile phone, a personal computer, a VR headset, a games console, etc., according to embodiments. The method 500 may be performed at least in part by hardware and/or software.

At item 510, data representing a three-dimensional object to be rendered is obtained. The data comprises a mesh structure modelling a geometry of the three-dimensional object, the mesh structure defining three-dimensional co-ordinates for each of a plurality of object vertices. The data also comprises a feature vector encoding visual characteristics for at least one object surface defined by the plurality of object vertices.

At item 520, motion information indicative of motion of the three-dimensional object in the scene is received.

At item 530, the mesh structure is deformed by adjusting the co-ordinates for one or more of the plurality of object vertices based on the received motion information.

At item 540, the deformed mesh structure is processed using a graphics pipeline comprising a vertex shader and a fragment shader to generate a rendered image of the scene. The fragment shader comprises an artificial neural network, ANN, trained to output pixel colour values for the at least one object surface on the basis of the visual characteristics encoded in the feature vector.

In embodiments, the feature vector encodes a radiance field for the three-dimensional object.

In embodiments, the feature vector comprises a multi-dimensional map of texture features configured to map any point on any surface of the mesh structure to at least one texture feature of the multi-dimensional map.

In embodiments, the ANN comprises a multilayer perceptron, MLP, configured to transform the visual characteristics encoded in the feature vector into the pixel colour values.

In embodiments, the ANN is trained by minimising a loss function between pixel colour values predicted by the ANN and pixel colour values of at least one existing image, the loss function comprising at least one of a photometric loss function, a silhouette loss function and a regularisation loss function.

In embodiments, the three-dimensional object comprises one of: a human head avatar for videoconferencing; and a video game character.

In embodiments, obtaining the data representing the three-dimensional object comprising retrieving the mesh structure from storage of the user device.

In embodiments, obtaining the data representing the three-dimensional object comprises retrieving the feature vector from storage of the user device.

In embodiments, one or more of the visual characteristics encoded in the feature vector are dependent on the motion of the three-dimensional object in the scene.

In embodiments, the feature vector and the ANN are trained together in an end-to-end manner using back-propagation of errors.

In embodiments, the mesh structure is generated using a mesh generating ANN, the mesh generating ANN being configured to output a mesh structure based on at least one existing image to minimise a loss function between rendered mesh points of the outputted mesh structure and pixel colour values of the at least one existing image, the loss function comprising at least one of a photometric loss function, a silhouette loss function and a regularisation loss function.

In embodiments, deforming the mesh structure comprising processing the received motion information using a deformation ANN, the deformation ANN being configured to output, based on the motion information, a vector that parameterizes an update function for adjusting the co-ordinates of the one or more of the plurality of object vertices, by minimising a loss function between at least one existing image and a rendering of the mesh structure after the parameterized update function has been applied to the mesh structure, the loss function comprising at least one of a photometric loss function, a silhouette loss function and a regularisation loss function.

In embodiments, deforming the mesh structure is based on a three-dimensional warp field, and wherein the three-dimensional warp field covers only a portion of the mesh structure.

In embodiments, the motion information is generated by a motion encoder comprising an artificial neural network configured to encode a motion vector based on at least one existing image. In embodiments, deforming the mesh structure comprises, at a motion decoder comprising an artificial neural network: decoding the motion vector encoded by the motion encoder, and determining, based on the motion vector, offsets for adjusting the co-ordinates of the one or more of the plurality of object vertices.

In embodiments, the motion information comprises data indicative of a weighted combination of blendshapes.

In embodiments, the method 500 comprises applying back-propagation of errors and stochastic gradient descent, using at least one loss function, to adjust parameters of one or more of: the artificial neural network comprised in the fragment shader; the feature vector; the mesh structure; a motion encoder configured to generate the motion information; and a deformation function configured to perform the deforming of the mesh structure.

In embodiments, the method 500 comprises modifying the feature vector based on the received motion information.

In embodiments, the method 500 comprises receiving, in an initial or offline stage, at least one of the mesh structure and the feature vector. In embodiments, the method comprises storing the at least one of the mesh structure and the feature vector in storage of the user device.

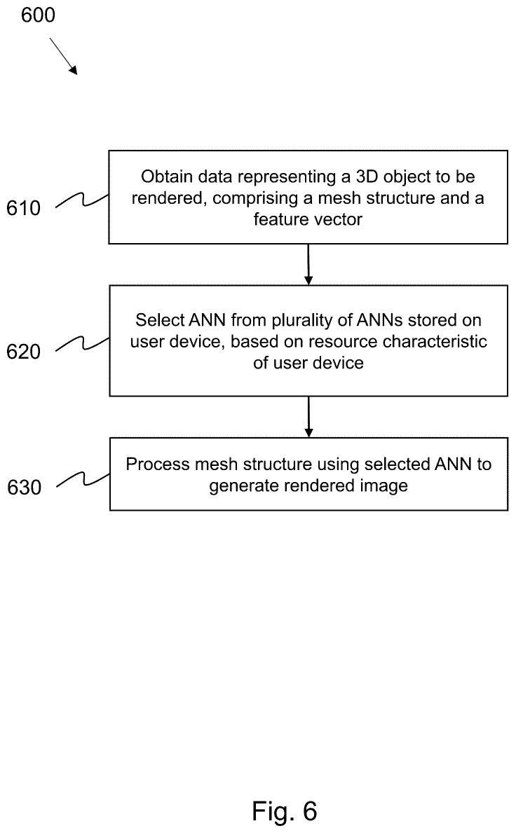

FIG. 6 shows a method 600 for generating a rendered image of a 3D object. The method 600 may be performed by a computing device such as a user device. The method 600 may be performed at least in part by hardware and/or software.

At item 610, data representing a three-dimensional object to be rendered is obtained. The data comprises a mesh structure modelling a geometry of the three-dimensional object, the mesh structure defining three-dimensional co-ordinates for each of a plurality of object vertices. The data also comprises a feature vector encoding visual characteristics of an object surface defined by the plurality of object vertices.

At item 620, an ANN is selected from a plurality of ANNs stored on the user device. Each of the plurality of ANNs is configured to output pixel colour values for the object surface based on at least some of the visual characteristics encoded in the feature vector. Different ANNs in the plurality of ANNs have different numbers of layers and/or different numbers of parameters. The selection is based on a resource characteristic of the user device.

At item 630, the mesh structure is processed using the selected ANN to generate a rendered image of the three-dimensional object.

In embodiments, different ANNs in the plurality of ANNs are configured to use different amounts of information encoded in the feature vector to determine the pixel colour values for the object surface.

In embodiments, the feature vector encodes a radiance field for the three-dimensional object.

In embodiments, the feature vector comprises a multi-dimensional map of texture features configured to map any point on any surface of the mesh structure to at least one texture feature of the multi-dimensional map.

In embodiments, a first ANN in the plurality of ANNs is configured to take only a first portion of the multi-dimensional map as input, and wherein a second ANN in the plurality of ANNs is configured to take the entire multi-dimensional map as input.

In embodiments, the selected ANN comprises a first ANN, and the method 600 comprises determining a change in the resource characteristic of the user device. The method 600 may further comprise, based on the determined change, selecting a second, different, ANN from the plurality of ANNs stored on the user device. The method 600 may comprise processing the mesh structure using the second ANN to generate a further rendered image of the three-dimensional object.

In embodiments, determining the change in the resource characteristic comprises determining a current computational load of the user device.

In embodiments, determining the change in the resource characteristic comprises determining whether the user device is in a power-saving mode and/or is being powered by a battery.

In embodiments, each ANN in the plurality of ANNs comprises a multilayer perceptron, MLP, configured to transform at least some of the visual characteristics encoded in the feature vector into the pixel colour values.

In embodiments, the method 600 comprises receiving, in an initial or offline stage, at least one of the mesh structure and the feature vector. In some such embodiments, the method 600 comprises storing the at least one of the mesh structure and the feature vector in storage of the user device.

In embodiments, the resource characteristic of the user device comprises one or more of: processing resources of the user device, memory resources of the user device, power resources of the user device; and a display size associated with the user device. Other examples of resource characteristic are envisaged.

In embodiments, each ANN in the plurality of ANNs is trained by minimising a loss function between pixel colour values predicted by the ANN and pixel colour values of at least one existing image, the loss function comprising at least one of a photometric loss function, a silhouette loss function and a regularisation loss function.

In embodiments, the three-dimensional object comprises one of: a human head avatar for videoconferencing; and a video game character.

In embodiments, obtaining the data representing the three-dimensional object comprising retrieving the mesh structure from storage of the user device.

In embodiments, obtaining the data representing the three-dimensional object comprises retrieving the feature vector from storage of the user device.

In embodiments, the method 600 comprises receiving motion information indicative of motion of the three-dimensional object in the scene. In such embodiments, processing the mesh structure may comprise: deforming the mesh structure by adjusting the co-ordinates for one or more of the plurality of object vertices based on the received motion information; and processing the deformed mesh structure using the selected ANN to generate the rendered image of the three-dimensional object.

In embodiments, processing the mesh structure comprises processing the mesh structure using a graphics pipeline comprising a vertex shader and a fragment shader, wherein the fragment shader comprises the selected ANN.

In embodiments, the feature vector and the plurality of ANNs are trained simultaneously in an end-to-end manner using back-propagation of errors.

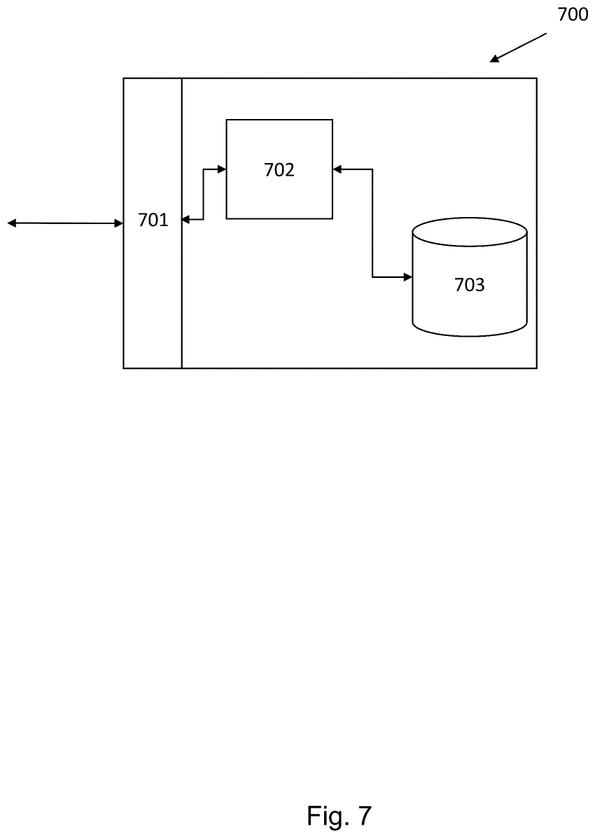

Embodiments of the disclosure include the methods described above performed on a computing device, such as the computing device 700 shown in FIG. 7. The computing device 700 comprises a data interface 701, through which data can be sent or received, for example over a network. The computing device 700 further comprises a processor 702 in communication with the data interface 701, and memory 703 in communication with the processor 702. In this way, the computing device 700 can receive data, such as image data or video data, via the data interface 701, and the processor 702 can store the received data in the memory 703, and process it so as to perform the methods of described herein, including generating rendered images.

Each device, module, component, machine or function as described in relation to any of the examples described herein may comprise a processor and/or processing system or may be comprised in apparatus comprising a processor and/or processing system. One or more aspects of the embodiments described herein comprise processes performed by apparatus. In some examples, the apparatus comprises one or more processing systems or processors configured to carry out these processes. In this regard, embodiments may be implemented at least in part by computer software stored in (non-transitory) memory and executable by the processor, or by hardware, or by a combination of tangibly stored software and hardware (and tangibly stored firmware). Embodiments also extend to computer programs, particularly computer programs on or in a carrier, adapted for putting the above described embodiments into practice. The program may be in the form of non-transitory source code, object code, or in any other non-transitory form suitable for use in the implementation of processes according to embodiments. The carrier may be any entity or device capable of carrying the program, such as a RAM, a ROM, or an optical memory device, etc.

The methods disclosed herein may be used for the generation of dynamic or temporal 3D representations of learned scenes. It marries the ease of use, scalability, and widespread compatibility of traditional, mesh-based 3D rendering pipelines with the seamless photorealism obtained with modern neural rendering models. For this purpose the methods take advantage of the explicit 3D geometry of meshes and the associated rendering pipeline for defining an object's coarse shape, and inject neural rendering algorithms during the rasterization and fragment shading step of the graphics pipeline. In particular, the 3D geometry of the mesh is used to efficiently query density and feature information from a neural radiance field and then a light-weight multilayer perceptron (MLP) is applied in the fragment shader of the 3D rendering pipeline. Temporal and dynamic changes to the 3D geometry can be encoded and decoded into offsets to a base mesh that has been learned from the scene. This provides for uses in applications including, but not limited to, dynamic head avatars for metaverse/teleconferencing applications, 3D video, and video game applications.

The present disclosure includes the following aspects:
1. The unique combination of deformable meshes and neural rendering. The disclosed methods uniquely represent dynamic scenes as a combination of traditional mesh-based rendering to define geometry with neural-based rendering to define texture, colour and material. A dedicated training pipeline produces abstract feature maps that are used as multi-dimensional textures by the MLP.
2. Instant deployability in traditional rendering pipelines. Unlike full neural rendering pipelines, the presently-disclosed methods do not require dedicated hardware or machine learning framework to operate during inference. Instead, the model leverages the fragment shader step in the graphics pipeline to deploy a light-weight neural network. This not only allows for the instant deployment of hybrid scenes in existing graphics frameworks such as Unity and Unreal, it also allows for the seamless mixture of traditional mesh/texture assets with hybrid mesh/neural assets within the same application.

The presently disclosed methods have numerous applications in the fields of computer graphics, computer vision, video games, and virtual and augmented reality.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the disclosure that are described as preferable, advantageous, convenient or the like are optional and do not limit the scope of the independent claims. Moreover, it is to be understood that such optional integers or features, whilst of possible benefit in some embodiments of the disclosure, may not be desirable, and may therefore be absent, in other embodiments.

The present disclosure also includes the following clauses:
Clause 1. A method to construct dynamic 3D visual representations combining an external mesh generation method in a computer graphics system that derives 3D coordinate points and a feature vector of at least 1 dimension comprising the texture information corresponding to these coordinate points and the 3D surface between points, an external neural-network based rendering method applied on the coordinates and texture of the mesh generation method to convert the output into colour information for the corresponding coordinate points, a mesh deformation process based on motion information extracted from an external scene motion generation method that transforms the colour and coordinate information into a warped representation in the 3D space, where the components of these three methods are trained with backpropagation and stochastic gradient descent to reconstruct at least one view of at least one available visual representation with at least one loss function.
Clause 2. A method according to clause 1 where the external mesh generation method is using at least one existing image and a mesh fitting method minimising at least one of photometric, silhouette, regularisation loss functions between the rendered mesh points and the colour representation of the image at the mesh points.
Clause 3. A method according to clause 1 where the external neural-network based rendering method is a multilayer perceptron comprising at least one layer that transforms the multidimensional texture information into colour information and which is trained by minimising at least one of photometric, silhouette, regularisation loss functions between the predicted colour and the colour of at least one existing image.
Clause 4. A method according to clause 1 where the mesh deformation process is a neural network consisting of at least one layer that transforms the motion information from at least one existing image to a vector that parametrizes an update function to the mesh and texture generated according to the mesh generation method, by minimising at least one of photometric, silhouette, regularisation loss functions between the existing image and the render of the mesh after the parameterized update function has been applied.
Clause 5. A method according to clause 4, where the mesh deformation process is combining:
   an encoder-style neural network that compresses the motion information from at least one image,
   a decoder-style neural network that decompresses the output of the encoder and produces a set of parameters for each mesh point as output,
   a deformation process that ingests the output of the decoder and transforms the mesh and texture information generated by the mesh generation method to reconstruct the deformed 3D scene representation.
Clause 6. An optimization algorithm according to clauses 1-5 that jointly applies backpropagation and stochastic gradient descent to adjust the internal parameters of
the rendering neural network,
the motion encoder,
the motion decoder,
the deformation function,
the abstract multi-dimensional feature map,
the base mesh
   to minimise at least one loss function of the reconstructed and deformed 3D scene representation and at least one view of that 3D scene representation that is captured by an external visual sensor.
Clause 7. A method according to clause 1, where the combination of all components models a neural radiance field.
Clause 8. A mesh fitting method according to clause 2, where the motion within the visual representation is estimated using a neural network, and which optimises a learnable base mesh from its initial state based on the estimated static parts of at least one view of the 3D scene and the rendering of the learnable base mesh using at least one loss function.
Clause 9. An initial mesh state according to clause 8, where the mesh is initialised according to a template of the object to be modelled, or where no such template exists, a mesh cube is used.
Clause 10. A method according to clause 1, where the feature vector containing texture information is an abstract multi-dimensional feature map that maps any point on any surface of the learned mesh to a feature on the abstract multi-dimensional feature map.
Clause 11. A method according to clause 8 and 10, where the information extracted from the external scene motion generation method is used to generate a dynamic residual that is applied to the abstract multi-dimensional feature map and updates it according to the motion information.
Clause 12. A method according to clause 1, where a standard 3D rendering pipeline is applied to the mesh and texture information and a neural network of at least one layer is used in the fragment shader on each rasterized pixel of the output image, that uses the information of the texture map and viewing direction to compute the final colour per pixel.
Clause 13. A method according to clause 4, where the update function is an external computer vision inference algorithm that estimates the mesh vertices of the dynamic parts and exchanges the moved vertices of the base mesh with the newly computed ones.
Clause 14. A method according to clause 4, where the motion of the scene is a linear combination of at least 1 blendshape. The individual blendshapes are all learned within the joint-optimization and the motion encoder and decoder output the weights that are used for the linear blending of the learned blendshapes.
Clause 15. A method according to clause 4, where the deformed mesh is rendered using the original view of the scene and quality metrics are used to assess the rendered results by comparing to the original image. The method refines the outputs of the motion encoder and decoder if a desired quality threshold is not met by iteratively performing the motion encoder, decoder, update and rendering step, each time by adding the information about erroneous regions to the sub-components.
Clause 16. A method according to clause 2 and 3, where the quality of the output rendering can be adapted to the available compute capabilities by only using partial information of the generated abstract texture map and learned parameters of the neural renderer within the fragment shader.
Clause 17. A computer-implemented method to construct dynamic 3D visual representations combining
   an external mesh generation method in a computer graphics system that derives 3D coordinate points and a feature vector of at least 1 dimension comprising the texture information corresponding to these coordinate points and the 3D surface between points, an external neural-network based rendering method applied on the coordinates and texture of the mesh generation method to convert the output into colour information for the corresponding coordinate points,
   a mesh deformation process based on motion information extracted from an external scene motion generation method that transforms the colour and coordinate information into a warped representation in the 3D space,
   where the components of these three methods are trained with backpropagation and stochastic gradient descent to reconstruct at least one view of at least one available visual representation with at least one loss function.
Clause 18. A computing device comprising:
   a processor; and
   a memory,
   wherein the computing device is arranged to perform, using the processor, a method according to any of clauses 1 to 17.
Clause 19. A computer program product arranged, when executed on a computing device comprising a processor and memory, to perform a method according to any of clauses 1 to 17.

1. A computer-implemented method for generating a rendered image of a scene, the scene comprising a three-dimensional object, the method comprising, at a user device:
obtaining data representing a three-dimensional object to be rendered, the data comprising:
a mesh structure modelling a geometry of the three-dimensional object, the mesh structure defining three-dimensional co-ordinates for each of a plurality of object vertices; and
a feature vector encoding visual characteristics for at least one object surface defined by the plurality of object vertices;
receiving motion information indicative of motion of the three-dimensional object in the scene;
deforming the mesh structure by adjusting the co-ordinates for one or more of the plurality of object vertices based on the received motion information; and
processing the deformed mesh structure using a graphics pipeline comprising a vertex shader and a fragment shader to generate a rendered image of the scene,
wherein the fragment shader comprises an artificial neural network, ANN, trained to output pixel colour values for the at least one object surface on the basis of the visual characteristics encoded in the feature vector.

2. The method according to claim 1, wherein the feature vector encodes a radiance field for the three-dimensional object.

3. The method according to claim 1, wherein the feature vector comprises a multi-dimensional map of texture features configured to map any point on any surface of the mesh structure to at least one texture feature of the multi-dimensional map.

4. The method according to claim 1, wherein the ANN comprises a multilayer perceptron, MLP, configured to transform the visual characteristics encoded in the feature vector into the pixel colour values.

5. The method according to claim 1, wherein the ANN is trained by minimising a loss function between pixel colour values predicted by the ANN and pixel colour values of at least one existing image, the loss function comprising at least one of a photometric loss function, a silhouette loss function and a regularisation loss function.

6. The method according to claim 1, wherein the three-dimensional object comprises one of: a human head avatar for videoconferencing; and a video game character.

7. The method according to claim 1, wherein obtaining the data representing the three-dimensional object comprising retrieving the mesh structure from storage of the user device.

8. The method according to claim 1, wherein obtaining the data representing the three-dimensional object comprises retrieving the feature vector from storage of the user device.

9. The method according to claim 1, wherein one or more of the visual characteristics encoded in the feature vector are dependent on the motion of the three-dimensional object in the scene.

10. The method according to claim 1, wherein the feature vector and the ANN are trained together in an end-to-end manner using back-propagation of errors.

11. The method according to claim 1, wherein the mesh structure is generated using a mesh generating ANN, the mesh generating ANN being configured to output a mesh structure based on at least one existing image to minimise a loss function between rendered mesh points of the outputted mesh structure and pixel colour values of the at least one existing image, the loss function comprising at least one of a photometric loss function, a silhouette loss function and a regularisation loss function.

12. The method according to claim 1, wherein deforming the mesh structure comprising processing the received motion information using a deformation ANN, the deformation ANN being configured to output, based on the motion information, a vector that parameterizes an update function for adjusting the co-ordinates of the one or more of the plurality of object vertices, by minimising a loss function between at least one existing image and a rendering of the mesh structure after the parameterized update function has been applied to the mesh structure, the loss function comprising at least one of a photometric loss function, a silhouette loss function and a regularisation loss function.

13. The method according to claim 1, wherein deforming the mesh structure is based on a three-dimensional warp field, and wherein the three-dimensional warp field covers only a portion of the mesh structure.

14. The method according to claim 1,
wherein the motion information is generated by a motion encoder comprising an artificial neural network configured to encode a motion vector based on at least one existing image; and
wherein deforming the mesh structure comprises, at a motion decoder comprising an artificial neural network: decoding the motion vector encoded by the motion encoder, and determining, based on the motion vector, offsets for adjusting the co-ordinates of the one or more of the plurality of object vertices.

15. The method according to claim 1, wherein the motion information comprises data indicative of a weighted combination of blendshapes.

16. The method according to claim 1, the method comprising applying back-propagation of errors and stochastic gradient descent, using at least one loss function, to adjust parameters of one or more of:
the ANN comprised in the fragment shader;
the feature vector;
the mesh structure;
a motion encoder configured to generate the motion information; and
a deformation function configured to perform the deforming of the mesh structure.

17. The method according to claim 1, the method comprising modifying the feature vector based on the received motion information.

18. The method according to claim 1, the method comprising:
receiving, in an initial or offline stage, at least one of the mesh structure and the feature vector; and
storing the at least one of the mesh structure and the feature vector in storage of the user device.

19. A computing device comprising:
a processor; and
memory;
wherein the computing device is arranged to perform, using the processor, operations comprising:
obtaining data representing a three-dimensional object to be rendered, the data comprising:
a mesh structure modelling a geometry of the three-dimensional object, the mesh structure defining three-dimensional co-ordinates for each of a plurality of object vertices; and
a feature vector encoding visual characteristics for at least one object surface defined by the plurality of object vertices;
receiving motion information indicative of motion of the three-dimensional object in the scene;
deforming the mesh structure by adjusting the co-ordinates for one or more of the plurality of object vertices based on the received motion information; and
processing the deformed mesh structure using a graphics pipeline comprising a vertex shader and a fragment shader to generate a rendered image of the scene,
wherein the fragment shader comprises an artificial neural network, ANN, trained to output pixel colour values for the at least one object surface on the basis of the visual characteristics encoded in the feature vector.

20. A non-transitory computer-readable medium storing software comprising instructions executable by one or more computers which, upon such execution, cause the one or more computers to perform operations comprising:
obtaining data representing a three-dimensional object to be rendered, the data comprising:
a mesh structure modelling a geometry of the three-dimensional object, the mesh structure defining three-dimensional co-ordinates for each of a plurality of object vertices; and
a feature vector encoding visual characteristics for at least one object surface defined by the plurality of object vertices;
receiving motion information indicative of motion of the three-dimensional object in the scene;
deforming the mesh structure by adjusting the co-ordinates for one or more of the plurality of object vertices based on the received motion information; and
processing the deformed mesh structure using a graphics pipeline comprising a vertex shader and a fragment shader to generate a rendered image of the scene,
wherein the fragment shader comprises an artificial neural network, ANN, trained to output pixel colour values for the at least one object surface on the basis of the visual characteristics encoded in the feature vector.
